(19) United States
(12) Patent Application Publication
(10) Pub. No.: US 2011/0165353 A1
(43) Pub. Date: Jul. 7, 2011

(54) COMPOSITE WOOD PRODUCT AND METHOD OF MANUFACTURE UTILIZING WOOD INFECTED BY BARK BEETLES

(75) Inventor: Suezone Chow, Richmond (CA)

(73) Assignee: Canadian Forest Products Ltd.

(21) Appl. No.: 13/055,434

(22) PCT Filed: Jul. 21, 2009
(86) PCT No.: PCT/CA09/01006

§ 371 Date: Mar. 24, 2011

(30) Foreign Application Priority Data
Jul. 21, 2008 (CA) 2,638,130

(51) Int. Cl. B32B 1/08; B32B 21/00; B32B 38/08

(52) U.S. Cl. 428/35.6; 428/541; 428/537.1; 156/258

(57) ABSTRACT

This application reveals a methodology for making a preserved composite wood product from wood infested with a fungus associated with a bark beetle, and the preserved composite wood product produced thereby. In one embodiment, the method involves profiling lumber to remove a portion of fungus infested wood or bark, leaving a profiled board having a bonding surface comprising a remaining portion of fungus infested wood, treating the profiled board with a liquid comprising a lumber additive, so that the board absorbs the liquid and the remaining portion of the fungus infested wood on the bonding surface acquires a retained concentration of the lumber additive, to form a treated board, and joining the bonding surface to one or more pieces of wood along a longitudinal junction, to form a composite wood product that has an interior and an exterior, so that an interior segment of the longitudinal junction is formed by the remaining portion of the fungus infested wood on the bonding surface located in the interior of the composite wood product, wherein the retained concentration of the lumber additive in the interior segment is at least as high as the concentration of the lumber additive at any point on the exterior of the composite wood product.

### FIELD OF THE INVENTION

This invention relates generally to a method for making a composite wood product from wood infested with a fungus associated with a bark beetle, and the composite wood product produced thereby. The composite wood product offers resistance to termite infestation and increases lumber recovery from fungal infested wood.

### BACKGROUND OF THE INVENTION

Bark beetles such as the Mountain Pine Beetle (Dendroctonus ponderosa Hopkins) (hereinafter referred to as “MPB”), Western Pine Beetle (Dendroctonus brevicomis LeConte), Douglas Fir Beetle (Dendroctonus pseudotsugae Hopkins), Spruce Beetle (Dendroctonus engelmanni Hopkins), and the Southern Pine Beetle (Dendroctonus frontalis Zimmermann), can devastate vast areas of forests. For example, the MPB has infested and continues to infest large stands of mature lodgepole pine (Pinus contorta var. latifolia Engelm) in Western Canada.

As summarized generally in U.S. Pat. No. 7,318,930, after boring into target trees, mated adult bark beetles dig galleries or channels under the bark where eggs are subsequently deposited. These eggs hatch into larvae which then feed on the cambium layer beneath the bark, creating channels which cut off the supply of water and nutrients, thereby killing the targeted tree. The larvae then pupate beneath the bark and finally adults emerge from the pupa chamber by boring out through the bark.

The infestation of targeted trees by bark beetles is known to be associated with a symbiotic fungal infection (U.S. Pat. No. 7,318,930). For example, fungi which reportedly associate with the MPB include Grosmannia clavigera, Ophiostoma montium, Ophiostoma calvigerum, and Leptographium longiclavatum. Collectively, these fungal symbionts of the MPB are referred to herein as “MPB-Associated Fungi”. It has been reported that as the MPB bore through bark and establish vertical egg galleries in the zone of inner bark, cambium and outer sapwood tissues, the spores of staining MPB-Associated Fungi are released resulting in the deposition of dark brown or black pigments in the sapwood. This is commonly called blue stain.

It has been reported that the deposition of blue stain occurs in the sapwood zone (i.e., the outer part of a wood log) (Chow and Obermajer, 2007). It has been demonstrated that after three years of infestation with MPB-Associated Fungi, the content (by volume) of blue stain in an infested log ranges from approximately 30% at the butt of the tree to approximately 70% at the top of the tree (Chow and Obermajer, supra). In lumber that contains wane, itself a natural defect in which there is a lack of wood on one or more edges of a piece of lumber, blue stain appears on the surface of the lumber.

Blue stain in sapwood has a detrimental effect on the appearance or aesthetic value of lumber. The deposit of dark pigments by the symbiotic fungi in the in the sapwood of lumber is not acceptable in “appearance grade lumber”. In certain markets around the world, blue stained lumber is not acceptable even in “construction grade” lumber. Additionally, the infestation of targeted trees by bark beetles can cause the logs to lose moisture and to develop checks or cracks along the log length and from bark to pith at a depth of approximately 70% (Kaffanke, 2003). Because of the cracks, it is reported that the lumber recovery from the logs is substantially reduced due to breakages. However, it has been reported that blue stain does not negatively affect lumber strength (Byrne, 2003; Ren and Lu, 2006).

This application reveals a methodology for making a preserved composite wood product from wood infected by bark beetles, and the preserved composite wood product produced thereby. The preserved composite wood product offers resistance to termite infestation and increases lumber recovery from fungal infested wood.

### SUMMARY OF THE INVENTION

In accordance with one aspect of the invention there is provided a method for producing a preserved elongate composite wood product from wood that has been infested with a fungus associated with a bark beetle. The method involves profiling lumber to remove a portion of fungus infested wood or bark, leaving a profiled board having a bonding surface comprising a remaining portion of fungus infested wood, treating the profiled board with a liquid comprising a lumber additive, so that the board absorbs the liquid and the remaining portion of the fungus infested wood on the bonding surface acquires a retained concentration of the lumber additive, to form a treated board, and joining the bonding surface to one or more pieces of wood along a longitudinal junction, to form a composite wood product that has an interior and an exterior, so that an interior segment of the longitudinal junction is formed by the remaining portion of the fungus infested wood on the bonding surface located in the interior of the composite wood product, wherein the retained concentration of the lumber additive in the interior segment is at least as high as the concentration of the lumber additive at any point on the exterior of the composite wood product.

In accordance with another aspect of the invention, there is provided a method for producing a preserved elongate composite wood product from wood that has been infested with a fungus associated with a bark beetle. The method involves profiling lumber to remove a portion of fungus infested wood or bark, leaving a profiled board having a bonding surface comprising a remaining portion of fungus infested wood, joining the bonding surface to one or more pieces of wood along a longitudinal junction, to form a composite wood product that has an interior and an exterior, so that an interior segment of the longitudinal junction is formed by the remaining portion of the fungus infested wood on the bonding surface located in the interior of the composite wood product, and so that the remaining portion of the fungus infested wood extends from the bonding surface in the interior of the composite wood product to the exterior of the composite wood product, forming a channel of fungus infested wood from the exterior to the interior of the composite wood product, and treating the composite wood product with a liquid comprising a lumber additive, so that the board absorbs the liquid through the channel of fungus infested wood, to deliver the lumber additive to the remaining portion of the fungus infested wood on the bonding surface, so that the remaining portion of the fungus infested wood on the bonding surface acquires a retained concentration of the lumber additive, to form a preserved elongate composite wood product.

The method may involve wood selected from more than one species of wood, whereby the composite wood product may involve a combination of wood species.

The method may involve wood selected from among spruce, pine, and fir.

The method may involve wood infested with a bark beetle, wherein the bark beetle is selected from one of the following: MPB, Western Pine Beetle, Douglas Fir Beetle, Spruce Beetle, and Southern Pine Beetle.

The method may involve wood infested with a fungus, wherein the fungus is associated with a bark beetle selected from one of the following: MPB, Western Pine Beetle, Douglas Fir Beetle, Spruce Beetle, and Southern Pine Beetle.

The method may involve wood infested with a fungus, wherein the fungus is selected from one of the following: Grosmannia clavigera, Ophiostoma montium, Ophiostoma calvigerum, and Leptographium longiclavatum.

The method may involve a lumber additive, wherein the lumber additive kills the fungus.

The method may involve a lumber additive, wherein the lumber additive is a wood preservative.

The method may involve a lumber additive, wherein the lumber additive kills termites.

The method may involve a lumber additive, wherein the lumber additive prevents termite infestation in the composite wood product.

The method may involve a longitudinal junction that encapsulates a passage.

The method may involve a passage that can receive a reinforcement bar.

The method may involve a passage that can receive a pipe.

The method may involve a passage that can receive a wire.

The method may involve lumber that may be profiled, and the bonding surface joined, so that an open passage is formed in the composite wood product, and the lumber additive flows through the open passage in the step of treating the profiled board.

The method may involve the retained concentration of the lumber additive in the interior segment being at least as high as the concentration of the lumber additive at any point on the exterior of the composite wood product.

The method may involve wood selected from more than one species of wood, whereby the composite wood product may involve a combination of wood species.

The method may involve wood selected from among spruce, pine, and fir.

The method may involve wood infested with a bark beetle, wherein the bark beetle is selected from one of the following: MPB, Western Pine Beetle, Douglas Fir Beetle, Spruce Beetle, and Southern Pine Beetle.

The method may involve wood infested with a fungus, wherein the fungus is associated with a bark beetle selected from one of the following: MPB, Western Pine Beetle, Douglas Fir Beetle, Spruce Beetle, and Southern Pine Beetle.

The method may involve wood infested with a fungus, wherein the fungus is selected from one of the following: Grosmannia clavigera, Ophiostoma montium, Ophiostoma calvigerum, and Leptographium longiclavatum.

The method may involve a lumber additive, wherein the lumber additive kills the fungus.

The method may involve a lumber additive, wherein the lumber additive is a wood preservative.

The method may involve a lumber additive, wherein the lumber additive kills termites.

The method may involve a lumber additive, wherein the lumber additive prevents termite infestation in the composite wood product.

In accordance with another aspect of the invention, there is provided a preserved composite wood product made by the methods described herein.

In accordance with another aspect of the invention, there is provided a preserved elongate composite wood product produced from wood that has been infested with a fungus associated with a bark beetle. The composite wood product includes a treated board produced from lumber profiled to remove a portion of fungus infested wood or bark, leaving a bonding surface comprising a remaining portion of fungus infested wood on a profiled board, wherein the profiled board is treated with a liquid comprising a lumber additive, so that the board absorbs the liquid and the remaining portion of the fungus infested wood on the bonding surface acquires a retained concentration of the lumber additive, to form the treated board, one or more pieces of wood joined to the bonding surface along a longitudinal junction to form the composite wood product, so that the composite wood product has an interior and an exterior, and an interior segment of the longitudinal junction is formed by the remaining portion of the fungus infested wood on the bonding surface located in the interior of the composite wood product, wherein the retained concentration of the lumber additive in the interior segment is at least as high as the concentration of the lumber additive at any point on the exterior of the composite wood product.

In accordance with another aspect of the invention, there is provided a preserved elongate composite wood product produced from wood that has been infested with a fungus associated with a bark beetle. The composite wood product includes a profiled board produced from lumber profiled to remove a portion of fungus infested wood or bark, leaving a bonding surface comprising a remaining portion of fungus infested wood on a profiled board, so that one or more pieces of wood are joined to the bonding surface along a longitudinal junction to form the composite wood product, so that the composite wood product has an interior and an exterior, and an interior segment of the longitudinal junction is formed by the remaining portion of the fungus infested wood on the bonding surface located in the interior of the composite wood product, and so that the remaining portion of the fungus infested wood extends from the bonding surface in the interior of the composite wood product to the exterior of the composite wood product, forming a channel of fungus infested wood from the exterior to the interior of the composite wood product. The composite wood product is treated with a liquid comprising a lumber additive, so that the board absorbs the liquid through the channel of fungus infested wood, to deliver the lumber additive to the remaining portion of the fungus infested wood on the bonding surface, so that the remaining portion of the fungus infested wood on the bonding surface acquires a retained concentration of the lumber additive, to form a preserved elongate composite wood product.

The composite wood product may further include more than one species of wood, whereby the composite wood product may include a combination of wood species.

The composite wood product may further include wood selected from among spruce, pine, and fir.

The composite wood product may further include wood infested with a bark beetle, wherein the bark beetle is selected from one of the following: MPB, Western Pine Beetle, Douglas Fir Beetle, Spruce Beetle, and Southern Pine Beetle.

The composite wood product may further include wood infested with a fungus, wherein the fungus is associated with a bark beetle selected from one of the following: MPB, Western Pine Beetle, Douglas Fir Beetle, Spruce Beetle, and Southern Pine Beetle.

The composite wood product may further include wood infested with a fungus, wherein the fungus is selected from one of the following: Grosmannia clavigera, Ophiostoma montium, Ophiostoma calvigerum, and Leptographium longiclavatum.

The composite wood product may further include a lumber additive, wherein the lumber additive kills the fungus.

The composite wood product may further include a lumber additive, wherein the lumber additive is a wood preservative.

The composite wood product may further include a lumber additive, wherein the lumber additive kills termites.

The composite wood product may further include a lumber additive, wherein the lumber additive prevents termite infestation in the composite wood product.

The composite wood product may further include a longitudinal junction that encapsulates a passage.

The composite wood product may further include a passage that can receive a reinforcement bar.

The composite wood product may further include a passage that can receive a pipe.

The composite wood product may further include a passage that can receive a wire.

In accordance with another aspect of the invention, there is provided a compound composite wood product comprising multiple laminations of the composite wood product described herein.

### BRIEF DESCRIPTION OF THE DRAWINGS

FIG. 1 is a cross-sectional view of lumber showing a method of producing a composite wood product from lumber, as described herein as an embodiment of the invention.

FIG. 2 is a cross-sectional view of lumber showing a method of producing a composite wood product from lumber, as described herein as an embodiment of the invention.

FIG. 3 is a perspective view of an elongate composite flat panel wood product, as described herein as an embodiment of the invention.

FIG. 4 is a perspective view of an elongate composite flat panel wood product, as described herein as an embodiment of the invention.

FIG. 5 is a cross-sectional view of multiple laminations of a composite wood product, as described herein as an embodiment of the invention.

FIG. 6 is a perspective view of an elongate composite flat panel wood product containing a longitudinal passage encapsulated by the longitudinal junction, as described herein as an embodiment of the invention.

FIG. 7 is a graphical illustration of the combined average of warping in a composite wood product as compared with control wood products, over a range of time at a given temperature and relative humidity.

FIG. 8 is a graphical illustration of the combined average of warping in a composite wood product as compared with control wood products, over a range of time at a given temperature and relative humidity.

FIG. 9 is a graphical illustration of the percentage of moisture absorption relative to the percentage of void area, in a composite wood product.

FIG. 10 is a graphical illustration of the percentage of borax solution absorption relative to the percentage of void area, in a composite wood product.

FIG. 11 is a graphical illustration of the percentage of moisture content distribution in representative cross-sections of composite wood products as compared with control wood products at defined sample positions as described herein.

### DETAILED DESCRIPTION

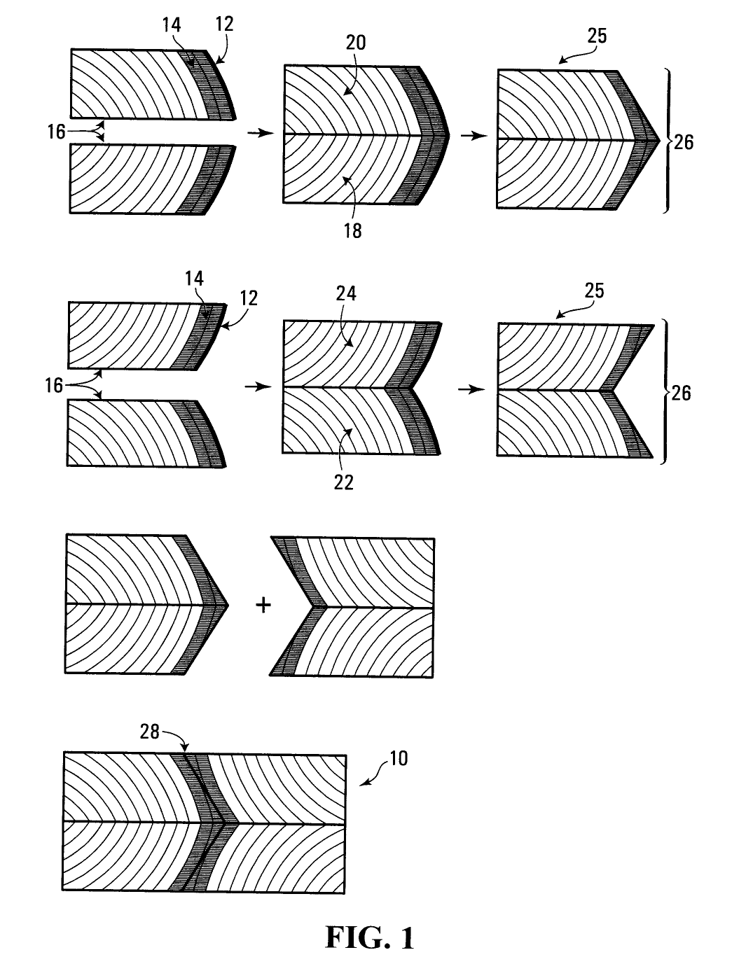

Referring to FIG. 1, in accordance with one aspect of the invention, there is provided a method for producing a preserved elongate composite wood product (10) from wood that has been infested with a fungus associated with a bark beetle.

The method involves profiling lumber to remove a portion of fungus infested wood (14) or bark (12), leaving a profiled board (25) having a bonding surface (26) comprising a remaining portion of fungus infested wood.

The profiled board can be produced by planing the lumber such that there are gluing surfaces (16). The gluing surfaces can be assembled such that their respective wane is oriented in either the same (e.g., 18 and 20) or opposite (e.g., 22 and 24) direction. As such, the profiled board (25) can exist in either a “male” (25; top panel) or “female” (25; lower panel) forms.

The profiled board (25) can be treated with a liquid comprising a lumber additive, so that the board absorbs the liquid and the remaining portion of the fungus infested wood on the bonding surface acquires a retained concentration of the lumber additive, to form a treated board.

The bonding surface (26) of one or more pieces of wood can be joined along a longitudinal junction (28) to form a composite wood product (10) that has an interior and an exterior, so that an interior segment of the longitudinal junction (28) is formed by the remaining portion of the fungus infested wood on the bonding surface (26) located in the interior of the composite wood product (10), wherein the retained concentration of the lumber additive in the interior segment is at least as high as the concentration of the lumber additive at any point on the exterior of the composite wood product (10).

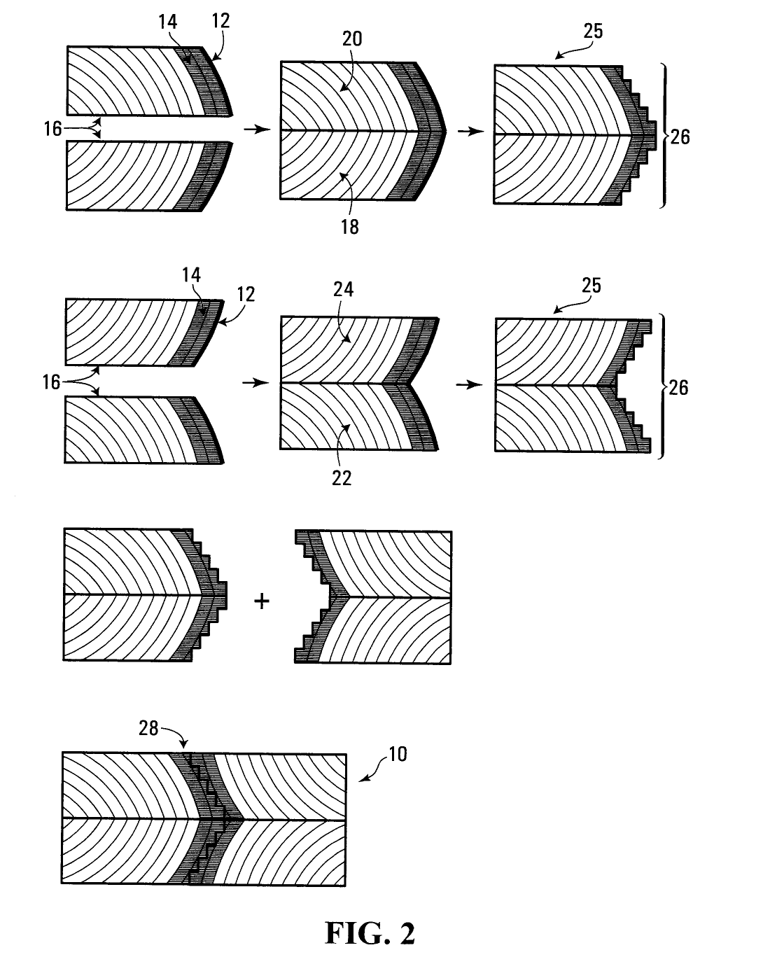

Referring to FIG. 2, in accordance with another aspect of the invention, the composite wood product (10) may be formed by stepwise bonding.

Referring to FIG. 1, in accordance with another aspect of the invention, there is provided a method for producing a preserved elongate composite wood product (10) from wood that has been infested with a fungus associated with a bark beetle.

The method involves profiling lumber to remove a portion of fungus infested wood (14) or bark (12), leaving a profiled board (25) having a bonding surface (26) comprising a remaining portion of fungus infested wood.

The profiled board can be produced by planing the lumber such that there are gluing surfaces (16). The gluing surfaces can be assembled such that their respective wane is oriented in either the same (e.g., 18 and 20) or opposite (e.g., 22 and 24) direction. As such, the profiled board (25) can exist in either a “male” (25; top panel) or “female” (25; lower panel) forms.

The bonding surface (26) of one or more pieces of wood can be joined along a longitudinal junction (28) to form a composite wood product (10) that has an interior and an exterior, so that an interior segment of the longitudinal junction (28) is formed by the remaining portion of the fungus infested wood on the bonding surface (26) located in the interior of the composite wood product (10), and so that the remaining portion of the fungus infested wood extends from the bonding surface in the interior of the composite wood product (10) to the exterior of the composite wood product, forming a channel of fungus infested wood from the exterior to the interior of the composite wood product (10).

The composite wood product (10) can be treated with a liquid comprising a lumber additive, so that the board absorbs the liquid through the channel of fungus infested wood, to deliver the lumber additive to the remaining portion of the fungus infested wood on the bonding surface (26), so that the remaining portion of the fungus infested wood on the bonding surface (26) acquires a retained concentration of the lumber additive, to form a preserved elongate composite wood product.

The method may involve wood selected from more than one species of wood. In these circumstances, the method would produce a composite wood product involving a combination of wood species. For example, the method may be utilized in conjunction with any one of the following species of wood: spruce, pine, and fir.

The method may involve wood infested with a bark beetle, wherein the bark beetle is selected from one of the following: MPB, Western Pine Beetle, Douglas Fir Beetle, Spruce Beetle, and Southern Pine Beetle.

The method may involve wood infested with a fungus, wherein the fungus is associated with a bark beetle selected from one of the following: MPB, Western Pine Beetle, Douglas Fir Beetle, Spruce Beetle, and Southern Pine Beetle.

The method may involve wood infested with a fungus, wherein the fungus is selected from one of the following: Grosmannia clavigera, Ophiostoma montium, Ophiostoma calvigerum, and Leptographium longiclavatum.

The method may involve a lumber additive, wherein the lumber additive kills the fungus.

The method may involve a lumber additive, wherein the lumber additive is a wood preservative.

The method may involve a lumber additive, wherein the lumber additive kills termites.

The method may involve a lumber additive, wherein the lumber additive prevents termite infestation, or other wood-destructive insects, in the composite wood product.

Examples of a lumber additive include: borax, alkalkine copper quat, chormated copper arsenate, copper azole, and didecyl dimethyl ammonium tetrafluoroborate (DBF).

The bonding surface (26) of one or more pieces of wood can be joined by using an adhesive. The adhesive can be water-resistant when the composite wood product (10) is formed prior to treatment with a water-base liquid, as described herein as an embodiment of the invention.

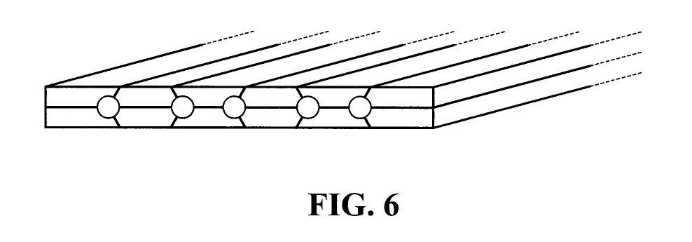

Referring to FIG. 6, an embodiment of the invention may involve a method wherein a longitudinal junction encapsulates a passage. With reference to FIG. 1, this objective can be achieved during the profiling of the profiled board (25). By casting a knife in the molder during the profiling stage of the method, a longitudinal hole can be added to the composite wood product such that the end product resembles the composite wood product depicted in FIG. 6, as compared with the composite wood product (10) depicted in FIG. 1.

An embodiment of the invention may involve a method wherein a passage is formed which can receive a reinforcement bar. The method may involve the formation of a passage that can receive a pipe. The method may involve the formation of a passage that can receive a wire.

The method may involve lumber that may be profiled, and the bonding surface joined, so that an open passage is formed in the composite wood product, and the lumber additive flows through the open passage in the step of treating the profiled board.

The method may involve the retained concentration of the lumber additive in the interior segment being at least as high as the concentration of the lumber additive at any point on the exterior of the composite wood product.

The method may involve wood selected from more than one species of wood. In these circumstances, the method would produce a composite wood product involving a combination of wood species. For example, the method may be utilized in conjunction with any one of the following species of wood: spruce, pine, and fir.

The method may involve wood infested with a bark beetle, wherein the bark beetle is selected from one of the following: MPB, Western Pine Beetle, Douglas Fir Beetle, Spruce Beetle, and Southern Pine Beetle.

The method may involve wood infested with a fungus, wherein the fungus is associated with a bark beetle selected from one of the following: MPB, Western Pine Beetle, Douglas Fir Beetle, Spruce Beetle, and Southern Pine Beetle.

The method may involve wood infested with a fungus, wherein the fungus is selected from one of the following: Grosmannia clavigera, Ophiostoma montium, Ophiostoma calvigerum, and Leptographium longiclavatum.

The method may involve a lumber additive, wherein the lumber additive kills the fungus.

The method may involve a lumber additive, wherein the lumber additive is a wood preservative.

The method may involve a lumber additive, wherein the lumber additive kills termites.

The method may involve a lumber additive, wherein the lumber additive prevents termite infestation, or other wood-destructive insects, in the composite wood product.

Examples of a lumber additive include: borax, alkalkine copper quat, chormated copper arsenate, copper azole, and didecyl dimethyl ammonium tetrafluoroborate (DBF).

In accordance with another aspect of the invention, there is provided a preserved composite wood product made by the methods described herein.

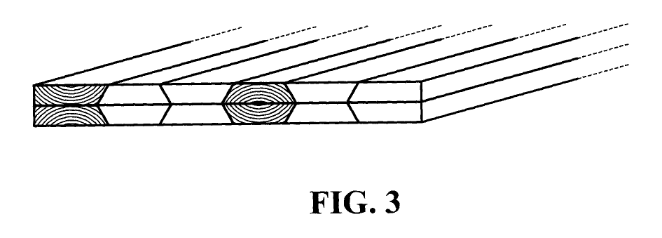

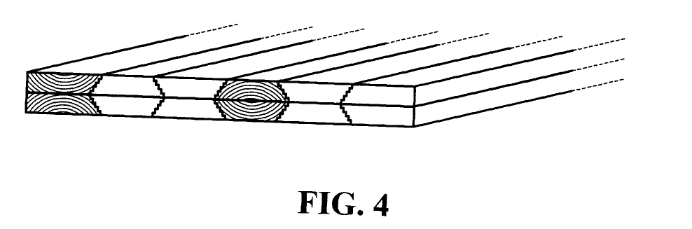

Referring to FIGS. 3 and 4, embodiments of the invention may involve the formation of a composite wood flat panel product. Referring to FIG. 4, the composite wood flat panel product may be formed by stepwise bonding.

Referring to FIG. 1, in accordance with another aspect of the invention, there is provided a preserved elongate composite wood product (10) produced from wood that has been infested with a fungus associated with a bark beetle.

The composite wood product includes a treated board produced from lumber profiled to remove a portion of fungus infested wood (14) or bark (12), leaving a bonding surface (26) comprising a remaining portion of fungus infested wood on a profiled board.

The profiled board (25) is treated with a liquid comprising a lumber additive, so that the board absorbs the liquid and the remaining portion of the fungus infested wood on the bonding surface acquires a retained concentration of the lumber additive, to form the treated board. The profiled board can be produced by planing the lumber such that there are gluing surfaces (16). The gluing surfaces can then assembled such that their respective wane is oriented in either the same (e.g., 18 and 20) or opposite (e.g., 22 and 24) direction. As such, the profiled board (25) can exist in either a “male” (25; top panel) or “female” (25; lower panel) forms.

The composite wood product includes one or more pieces of wood joined to the bonding surface (26) along a longitudinal junction (28) to form the composite wood product (10), so that the composite wood product (10) has an interior and an exterior, and an interior segment of the longitudinal junction (28) is formed by the remaining portion of the fungus infested wood on the bonding surface located in the interior of the composite wood product (10), wherein the retained concentration of the lumber additive in the interior segment is at least as high as the concentration of the lumber additive at any point on the exterior of the composite wood product (10).

Referring to FIG. 1, in accordance with another aspect of the invention, there is provided a treated composite wood product (10) produced from wood that has been infested with a fungus associated with a bark beetle.

The composite wood product (10) includes a profiled board (25) produced from lumber profiled to remove a portion of fungus infested wood (14) or bark (12), leaving a bonding surface (26) comprising a remaining portion of fungus infested wood on a profiled board (25).

One or more pieces of wood are joined to the bonding surface (26) along a longitudinal junction (28) to form the composite wood product (10), so that the composite wood product (10) has an interior and an exterior, and an interior segment of the longitudinal junction (28) is formed by the remaining portion of the fungus infested wood on the bonding surface (26) located in the interior of the composite wood product (10), and so that the remaining portion of the fungus infested wood extends from the bonding surface in the interior of the composite wood product (10) to the exterior of the composite wood product (10), forming a channel of fungus infested wood from the exterior to the interior of the composite wood product (10).

The composite wood product (10) is treated with a liquid comprising a lumber additive, so that the composite wood product absorbs the liquid through the channel of fungus infested wood, to deliver the lumber additive to the remaining portion of the fungus infested wood on the bonding surface (26), so that the remaining portion of the fungus infested wood on the bonding surface (26) acquires a retained concentration of the lumber additive, to form a treated composite wood product.

The composite wood product may further include more than one species of wood. In these circumstances, the composite wood product would include a combination of wood species. For example, the composite wood product may further include wood selected from among spruce, pine, and fir.

The composite wood product may further include wood infested with a bark beetle, wherein the bark beetle is selected from one of the following: MPB, Western Pine Beetle, Douglas Fir Beetle, Spruce Beetle, and Southern Pine Beetle.

The composite wood product may further include wood infested with a fungus, wherein the fungus is associated with a bark beetle selected from one of the following: MPB, Western Pine Beetle, Douglas Fir Beetle, Spruce Beetle, and Southern Pine Beetle.

The composite wood product may further include wood infested with a fungus, wherein the fungus is selected from one of the following: Grosmannia clavigera, Ophiostoma montium, Ophiostoma calvigerum, and Leptographium longiclavatum.

The composite wood product may further include a lumber additive, wherein the lumber additive kills the fungus.

The composite wood product may further include a lumber additive, wherein the lumber additive is a wood preservative.

The composite wood product may further include a lumber additive, wherein the lumber additive kills termites.

The composite wood product may further include a lumber additive, wherein the lumber additive prevents termite infestation in the composite wood product.

Examples of a lumber additive include: borax, alkalkine copper quat, chormated copper arsenate, copper azole, and didecyl dimethyl ammonium tetrafluoroborate (DBF).

Referring to FIG. 6, an embodiment of the invention may involve a composite wood product wherein a longitudinal junction encapsulates a passage. An embodiment of the invention may include a composite wood product wherein a passage is formed which can receive a reinforcement bar. The composite wood product may further include the formation of a passage that can receive a pipe. The composite wood product may further include the formation of a passage that can receive a wire.

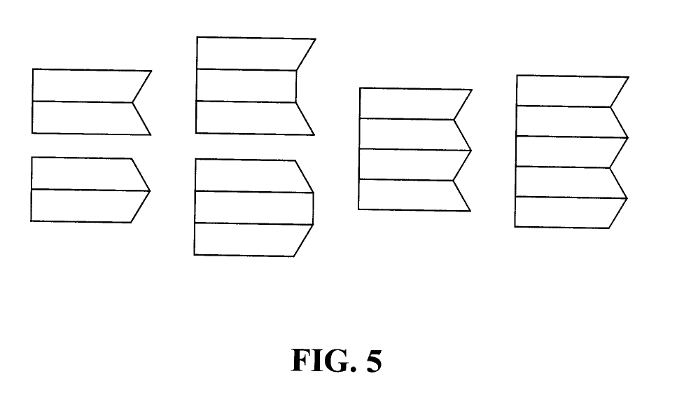

Referring to FIG. 5, in accordance with another aspect of the invention, there is provided a compound composite wood product comprising multiple laminations of the composite wood product described herein. FIG. 5 depicts examples of 2-, 3-, 4-, and 5-part laminations.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

### EXAMPLES

### Example 1

### Aesthetic Appearance is Improved in Composite Wood Post Products Produced from MPB-Infested Wood

A study was conducted in order to observe the aesthetic value of the composite wood post product, as shown generally at 10 in FIG. 1. A total of approximately 200 pieces of 2″×4″×8′ utility grade lumber were sorted into four categories based on the degree of wane. Two points of wane along the length of each piece of lumber were measured and averaged to determine the grade type. The resultant four grade types were defined as follows: Grade 1 (no wane); Grade 2 (¼″<average</=½″); Grade 3 (½″<average</=¾″); and Grade 4 (>¾″ wane). Approximately 48 pieces of 2″×4″×8′ No. 2 and better grade lumber without wane were selected as a control for this study.

After sorting, 24 pieces of lumber were randomly selected from each grade as defined herein. A total of 96 pieces of 2″×4″×8′ utility grade lumber with wane and blue stained sapwood were selected.

All lumber was planed to a thickness of 1.5 inches on the two wide faces. The utility grade lumber was assembled into “male” and “female” pairs, as detailed herein and as shown generally at 25 in FIG. 1. Exterior-use phenol-resorcinol glue was applied to the surfaces. The surfaces were pressed at 90° C. for 30 minutes under a pressure of 125 psi. Controls were also pressed under the same conditions with 2 pieces of lumber being glued face-to-face.

The resulting pieces of utility lumber assemblies were profiled into “male” and “female” components using planar knives having an angle of approximately 15°. Phenol-resorcinol glue was spread on the profiled surfaces and the surfaces were pressed at 90° C. for 30 minutes under 125 psi of pressure.

The appearance of the resultant composite wood post products was examined for the percent of averaged void area in both end sections and the percent of blue stain areas on the external surfaces of the posts as shown in Table 1.

TABLE 1
Relationship between wane grade, wane size and blue stain in composite
wood post products

Wane grade

| | | | |
|---|---|---|---|
| 1 | 2 | 3 | 4 |

Wane size

| | | | |
|---|---|---|---|
| 0″ | ¼″-½″ | ½″-¾″ | >¾″ |

| | | | | |
|---|---|---|---|---|
| Avg. void area in post (%) | 0 | 1.5 | 1.1 | 5.7 |
| Avg. blue stain in surface | 0 | 1.2 | 10 | 8.6 |
| of post (%) | | | | |

As depicted in Table 1, the average void area in the center of the composite wood product posts increases with the increase of wane grade and size. At a wane size of greater than ¾″, the average void area is about 6% of the end section.

It should be noted that the MPB-infested utility lumber had an average percentage of blue stain in lumber surface of 49% (S.D.=33%). As depicted in Table 1 above, the blue stain on the surface area of the products is reduced from 49% to about 10%.

### Example 2

### Aesthetic Appearance of the Longitudinal Joint in Composite Wood Products

A study was conducted in order to observe the aesthetic value of the composite wood product formed by stepwise bonding as described in WO 02/068164 (Chow et al.). A study was conducted wherein 400 pieces of lumber were profiled using a series of right-angled steps, as detailed in Chow et al. The profiled lumber was then joined, as detailed in Chow et al. The blue stain on the surface of the resultant composite wood product was reduced from approximately 50% prior to the production of the composite wood product, to approximately 15% following the production of the composite wood product. The water absorption characteristics of this product are shown in Example 6.

### Example 3

### Strength Properties of Composite Wood Post Products

A study was conducted in order to observe the strength properties of the composite wood post products. The static bending test in accordance with the ASTM standard D198 using 4-point loading with a span of 1245 mm and a load span of 415 mm was employed. Crosshead speed was at 3.14 mm/min so to achieve the maximum load in about 10 minutes. The sample dimensions were 2.6″×3.4″×6′ for both the control and the composite wood products produced by an embodiment of the methodology described herein.

Four composite wood post products, termed NP1, NP2, NP3, and NP4, were studied; the terms NP1, NP2, NP3, and NP4 describe the four grades of wane as described herein and were present in a post form as described generally in FIG. 1. NP is an inventor's term for “New Product”. Moisture content and density were determined for each post prior to testing.

Table 2 depicts the static bending strengths and the void ratio in the end section of the posts. The highest ratio of void to total area was for the NP4 composite wood post products. Overall, the average percentage of void to total area was 2.1%.

TABLE 2
Bending strength summary

| | | Avg. | | | | |
|---|---|---|---|---|---|---|
| | | MC | Density | MOR | MOE | Avg. Void |
| Sample | | (%) | (g/cm³) | (psi) | (psi) | Area (%) |
| Control | Average | 14 | 0.51 | 8151 | 1617511 | 0 |
| Average | SD | 0.83 | 0.04 | 1749 | 217126 | |
| | CV (%) | 6 | 7.1 | 21.5 | 13.4 | |
| Control A | Average | 13.9 | 0.51 | 8077 | 1610478 | 0 |
| Cup In | SD | 0.7 | 0.04 | 1830 | 182700 | |
| | CV (%) | 5.2 | 7 | 22.7 | 11.3 | |
| Control B | Average | 14 | 0.51 | 8245 | 1626553 | 0 |
| Cup Out | SD | 1.01 | 0.04 | 1777 | 270526 | |
| | CV (%) | 7.2 | 7.8 | 21.6 | 16.6 | |
| NP Average | Average | 14.2 | 0.5 | 8254 | 1593919 | 2.1 |
| | SD | 0.74 | 0.02 | 1112 | 130222 | |
| | CV (%) | 5.2 | 5 | 13.5 | 8.2 | |
| NP-1 | Average | 13.5 | 0.5 | 8154 | 1510342 | 0 |
| | SD | 0.6 | 0.02 | 738 | 42736 | |
| | CV (%) | 4.2 | 5 | 9 | 2.8 | |
| NP-2 | Average | 14.3 | 0.5 | 8480 | 1594054 | 1.5 |
| | SD | 0.6 | 0.03 | 1107 | 196274 | |
| | CV (%) | 4.4 | 6 | 13.1 | 12.3 | |
| NP-3 | Average | 14.9 | 0.52 | 8000 | 1608963 | 1.1 |
| | SD | 0.5 | 0.02 | 1797 | 137678 | |
| | CV (%) | 3.1 | 3.9 | 22.5 | 8.6 | |
| NP-4 | Average | 14.2 | 0.5 | 8345 | 1642776 | 5.7 |
| | SD | 0.7 | 0.02 | 941 | 104983 | |
| | CV (%) | 4.7 | 4.8 | 11.3 | 6.4 | |

Note:
SD: Standard Deviation
CV: Coefficient of Variation
NP: New Product
Each sample is a replicate of 6 specimens.

The average modulus of rupture for the NP posts (8254 psi) was slightly higher than the Control A (8077 psi) or Control B (8245 psi) samples. Statistical analysis was performed using the T-test on each of the wane grade types as compared to all the controls. There was no significant difference in either the modulus of rupture (hereinafter referred to as “MOR”) or the modulus of elasticity (hereinafter referred to as “MOE”) for the NP(1-4) composite wood post products. The NP(1-4) composite wood product posts made of utility grade lumber yielded equal strength data as that of control posts made of No. 2 and better grade lumber. The coefficient of variation on both MOR and MOE for the NP(1-4) posts was lower (13.5% and 8.2%, respectively) than that of the control samples (21.5% and 13.5%, respectively).

### Example 4

### Dimensional Stability of Composite Wood Post Products

A study was conducted in order to observe the dimensional stability of composite wood post products. Sample dimensions for the stability test of both the control and the composite wood products [NP(1-4), as described herein] were 2.5″×6.45″×6′. Samples were tested in triplicate. Temperature and humidity of the 2 conditions were logged during the 3-week test period. Average room temperature and humidity (hereinafter referred to as “RH”) were 24.2° C. and 42.4% RH while average oven conditions were 32.5° C. and 30.9% RH. During the conditioning periods, moisture content and warping of the posts were measured. Warping is a summation of cup, bow, twist and crook data in accordance with NLGA grading rules.

The results of 3-week conditioning indicated that the moisture absorption for control and NP(1-4) products were similar. They were within the range of 12.4% to 13.8% based on oven dry weight.

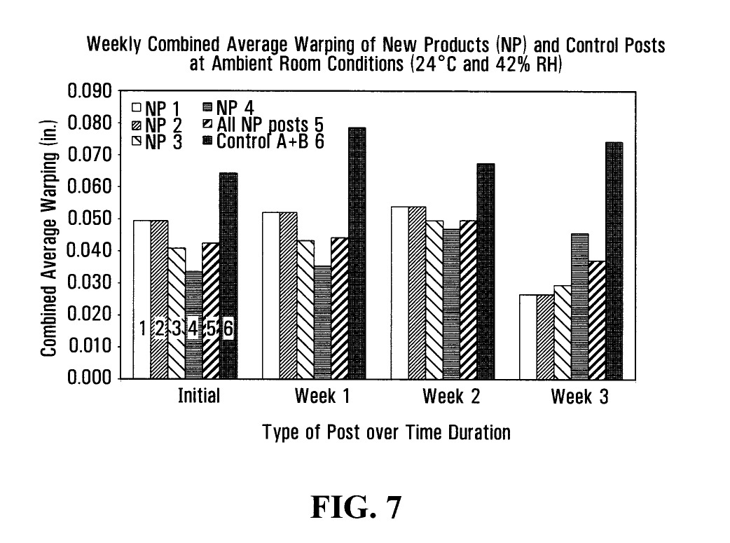

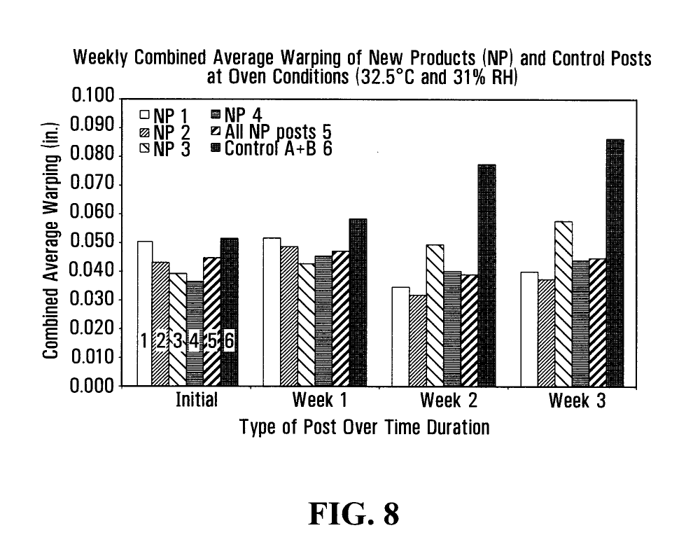

The results for warping at the end of 3-week condition period are presented graphically in FIG. 7 and FIG. 8 herein. Statistical analysis indicated that there was no significant difference in warping tests between the 4 types of NP posts. However, the control posts had higher warping than the NP posts. The combined average warps for control posts were 0.074″ at room conditions and 0.086″ at oven conditions. The average warps for the NP posts were 0.037″ at room conditions and 0.045″ at oven conditions.

### Example 5

### Absorption and Liquid Penetration in Composite Wood Products

A study was conducted in order to observe the absorption and liquid penetration in composite wood products. The study was focussed on examining the effect of the void area of the post on the penetration of water or a 5% borate solution, a wood preservative, into the center of the post after a vacuum-pressure process.

The NP(1-4) composite wood post products were used. Two 1′ samples each were cut from two controls, a Grade 1 composite wood post product, a Grade 2 composite wood post product, a Grade 3 composite wood post product, and two Grade 4 composite wood post product. The dimensions, weight and initial moisture content were measured on all samples.

The 1′ samples were placed vertically in the pressure vessel using wire spacers to ensure even water absorption around specimens. Samples were weighted and then immersed in water. A vacuum of 25 mm Hg was applied for 30 minutes followed by a pressure cycle of 60 psi for 60 minutes.

Samples were removed and immediately weighed. Two ½″ samples were cut at 2″ from one end and at the center of the examined post. An outline of the “wetted area” was drawn on each sample. Moisture content determinations were conducted on these specimens. A ¼″ specimen was also cut adjacent to the moisture content samples for a cross sectional moisture content analysis. All samples were dried in an oven set to 103° C. overnight.

A second set of experiments were conducted as described in this Example using a 5% solution of sodium octaborate tetrahydrate.

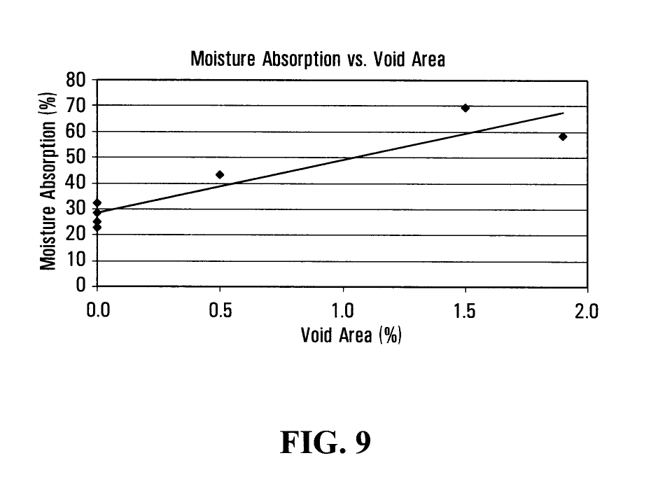

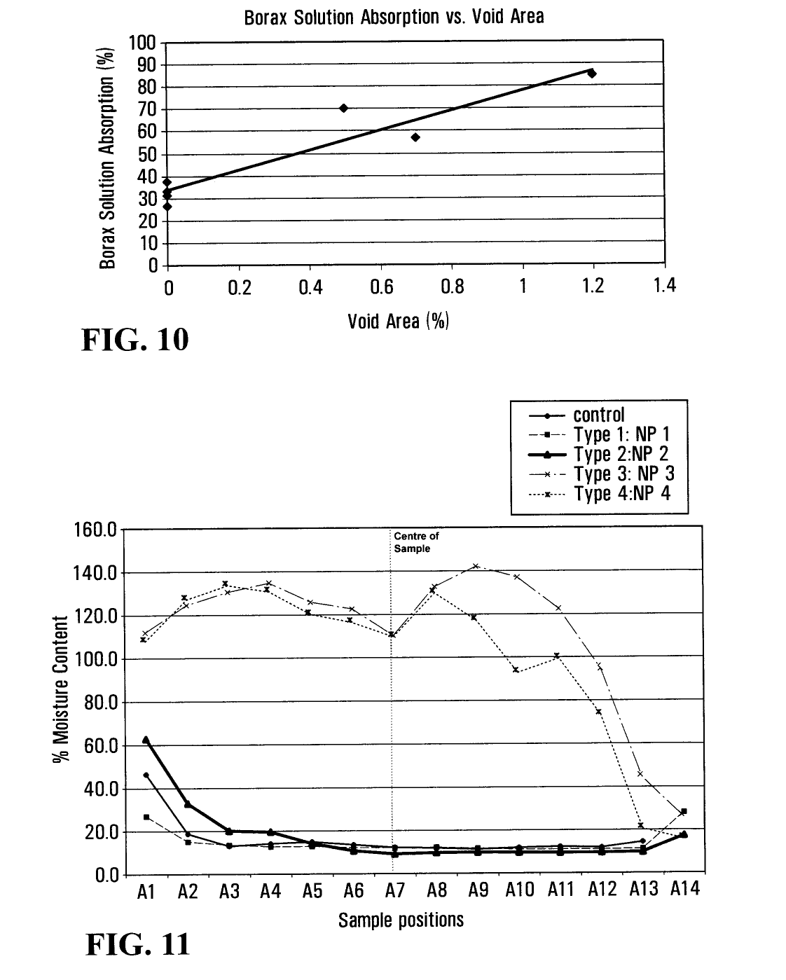

The % void area and the % absorption data are depicted in Table 3. The results in Table 3 indicate that the presence of center void due to the quantity and orientation of wane in the NP3 and NP4 composite wood post products have an effect on the increase of moisture content in the composite wood post product. Moisture content and 5% borate absorption of the posts are depicted graphically in FIG. 9 and FIG. 10 herein. Using linear equations for the statistics generated herein indicated that the regression correlation (R2) were 0.847 and 0.816 for water and 5% borate absorption.

TABLE 3
Data for void area and absorption of composite wood post
products

| | | |
|---|---|---|
| | Void Area | Absorption |
| Sample | (%) | (%) |

Water Treatment

| | | |
|---|---|---|
| Control A | 0 | 32.1 |
| Control B | 0 | 22.7 |
| NP-1 | 0 | 24.9 |
| NP2 | 0 | 28.6 |
| NP-3 | 0.5 | 43.1 |
| NP-4 | 1.9 | 58.4 |
| NP-4 | 1.5 | 69.4 |

5% Borate Treatment

| | | |
|---|---|---|
| Control A | 0 | 33.1 |
| Control B | 0 | 26.6 |
| NP-1 | 0 | 37.6 |
| NP-2 | 0 | 31.4 |
| NP-3 | 0.7 | 57.1 |
| NP-4 | 0.5 | 70.3 |
| NP-4 | 1.2 | 85 |

Each sample was a replicate of two specimens

The composite wood post product made of Grade 3 and 4 wane lumber had the greatest amount of both water and 5% borate solution absorption especially in the center area of the post. This is depicted graphically in FIG. 11, which shows the percentage of moisture content at 14 sample positions for each of the composite wood post products and the control samples.

### Example 6

### Absorption Properties in Composite Wood Flat Panel Products

A study was conducted to examine the absorption and liquid penetration in composite wood flat panel products. MPB-infested and control lumber were used in this study with dimensions of 2″×6″×8′. The lumber was step profiled as described in Chow et al. Melamine formaldehyde glue was used to bond the lumber pieces side by side under 150 psi pressure. The moisture content of the lumber was averaged 13.82% (SD: 1.02%).

After the gluing and conditioning, the bonded lumbers were maintained at room temperature for one week. Thereafter, one foot long samples were cut along the length of each joined lumber.

Three groups of test samples were available for comparison: 1 control sample and 2 samples of infested, blue stained product.

The one foot long samples were placed vertically in a pressure vessel using wire spacers to ensure even water absorption around specimens. Samples were weighted and then immersed in water. A vacuum of 25 mm Hg was applied for 30 minutes followed by a pressure cycle of 60 psi for 60 minutes. Two cycles of the same treatment were done.

After the treatment, samples were removed and immediately weighed and the moisture absorptions were calculated as shown in Table 4.

TABLE 4
Moisture absorption of non-infested and blue stained wood samples

| | | Blue | |
|---|---|---|---|
| | | stained | Blue stained |
| | Control | sample 1 | sample 2 |
| Average (%) | 44 | 104 | 66 |
| SD (%) | 16 | 30 | 13 |

Thereafter, each sample was sawn lengthwise into 3 sections: a middle section with the glue line referencing the center and two additional sections adjacent to the middle section. A one-inch wide strip was removed lengthwise from the center of each section as defined herein. Each wood strip was weighed and then dried in an oven at 103° C. for 12 hours. The oven-dry weights of samples were recorded as in Table 5 for observing the moisture content distributions.

TABLE 5
Moisture distribution in internal samples of non-infested and
blue stained wood samples

| | | | Blue stained | | Blue stained | |
|---|---|---|---|---|---|---|
| | Control | | sample 1 | | sample 2 | |
| | Middle | Sides | Middle | Sides | Middle | Sides |
| Average (%) | 43 | 43 | 102 | 92 | 105 | 61 |
| SD (%) | 15 | 27 | 32 | 34 | 20 | 20 |

This Example indicates that the step profiled joint with MPB-infested, blue stained wood both reduced the blue stain from the surface of the product, and enhanced the absorption following preservative treatment. The results indicate that the glue line region (i.e., Middle) demonstrated higher absorption than the Sides. The high absorption in the Middle correlated with higher levels of moisture distribution on the Sides.

### REFERENCES

1. U.S. Pat. No. 7,318,930; “Control methods for boring bark beetles” (Steed)
2. Chow S. and Obermajer A. (2007) Moisture and blue stain distribution in mountain pine beetle infested lodgepole pine trees and industrial implications. Journal Wood Sci. Technol. 41: 3-16.
3. Kaffanke T. (2003) Effect of stand variables on the quality and longevity of mountain pine beetle-killed lodgepole pine in Plateau's operating area. T. Kaffanke Consulting Ltd. p. 54.
4. Byrne T. (2003) Characterizing the properties of wood containing beetle-transmitted bluestain: background, material collection, and summary of findings. Forintek Canada Corp Report, p. 8.
5. Ren H.Q. and Lu J. (2006) Characterizing the properties of bluestained lodgepole pine wood of British Columbia, Canada. Chinese Academy of Forestry (Beijing), p 39.
6. WO 02/068164; “Composite wood product and method of manufacture” (Chow et al.)

1-43. (canceled)

44. A method for producing a preserved elongate composite wood product from wood that has been infested with a fungus associated with bark beetle, the method comprising:
profiling lumber to remove a portion of fungus infested wood or bark, leaving a profiled board having a bonding surface comprising a remaining portion of fungus infested wood;
treating the profiled board with a liquid comprising a lumber additive, so that the board absorbs the liquid and the remaining portion of the fungus infested wood on the bonding surface acquires a retained concentration of the lumber additive, to form a treated board; and
joining the bonding surface to one or more pieces of wood along a longitudinal junction, to form a composite wood product that has an interior and an exterior, so that an interior segment of the longitudinal junction is formed by the remaining portion of the fungus infested wood on the bonding surface located in the interior of the composite wood product,
wherein the retained concentration of the lumber additive in the interior segment is at least as high as the concentration of the lumber additive at any point on the exterior of the composite wood product.

45. A method for producing a preserved elongate composite wood product from wood that has been infested with a fungus associated with a bark beetle, the method comprising:
profiling lumber to remove a portion of fungus infested wood or bark, leaving a profiled board having a bonding surface comprising a remaining portion of fungus infested wood;
joining the bonding surface to one or more pieces of wood along a longitudinal junction, to form a composite wood product that has an interior and an exterior, so that an interior segment of the longitudinal junction is formed by the remaining portion of the fungus infested wood on the bonding surface located in the interior of the composite wood product, and so that the remaining portion of the fungus infested wood extends from the bonding surface in the interior of the composite wood product to the exterior of the composite wood product, forming a channel of fungus infested wood from the exterior to the interior of the composite wood product; and
treating the composite wood product with a liquid comprising a lumber additive, so that the composite wood product absorbs the liquid through the channel of fungus infested wood, to deliver the lumber additive to the remaining portion of the fungus infested wood on the bonding surface, so that the remaining portion of the fungus infested wood on the bonding surface acquires a retained concentration of the lumber additive, to form a preserved elongate composite wood board.

46. The method of claim 44, wherein the wood is selected from more than one species of wood, whereby the composite wood product comprises a combination of wood species.

47. The method of claim 44, wherein the wood is selected from among spruce, pine, and fir.

48. The method of claim 44, wherein said bark beetle is selected from one of the following: MPB, Western Pine Beetle, Douglas Fir Beetle, Spruce Beetle, and Southern Pine Beetle.

49. The method of claim 44, wherein said fungus is associated with a bark beetle selected from one of the following: MPB, Western Pine Beetle, Douglas Fir Beetle, Spruce Beetle, and Southern Pine Beetle.

50. The method of claim 44, wherein said fungus is selected from one of the following: Grosmannia clavigera, Ophiostoma montium, Ophiostoma calvigerum, and Leptographium longiclavatum.

51. The method of claim 44, wherein said lumber additive kills said fungus.

52. The method of claim 51, wherein said lumber additive is a wood preservative.

53. The method of claim 51, wherein said lumber additive kills termites.

54. The method of claim 51, wherein said lumber additive prevents termite infestation in said composite wood product.

55. The method of claim 44, wherein said longitudinal junction encapsulates a passage.

56. The method of claim 55, wherein said passage can receive a reinforcement bar.

57. The method of claim 55, wherein said passage can receive a pipe.

58. The method of claim 55, wherein said passage can receive a wire.

59. The method of claim 45, wherein the lumber is profiled, and the bonding surface joined, so that an open passage is formed in the composite wood product, and the lumber additive flows through the open passage in the step of treating the profiled board.

60. The method of claim 45, wherein the retained concentration of the lumber additive in the interior segment is at least as high as the concentration of the lumber additive at any point on the exterior of the composite wood product.

61. The method of claim 59, wherein the wood is selected from more than one species of wood, whereby the composite wood product comprises a combination of wood species.

62. The method of claim 61, wherein the wood is selected from among spruce, pine, and fir.

63. The method of claim 62, wherein said bark beetle is selected from one of the following: MPB, Western Pine Beetle, Douglas Fir Beetle, Spruce Beetle, and Southern Pine Beetle.

64. The method of claim 62, wherein said fungus is associated with a bark beetle selected from one of the following: MPB, Western Pine Beetle, Douglas Fir Beetle, Spruce Beetle, and Southern Pine Beetle.

65. The method of claim 64, wherein said fungus is selected from one of the following: Grosmannia clavigera, Ophiostoma montium, Ophiostoma calvigerum, and Leptographium longiclavatum.

66. The method of claim 65, wherein said lumber additive kills said fungus.

67. The method of claim 66, wherein said lumber additive is a wood preservative.

68. The method of claim 66, wherein said lumber additive kills termites.

69. The method of claim 66, wherein said lumber additive prevents termite infestation in said composite wood product.

70. A preserved composite wood product made by the method of claim 44.

71. A preserved elongate composite wood product produced from wood that has been infested with a fungus associated with a bark beetle, the composite wood product comprising: a treated board produced from lumber profiled to remove a portion of fungus infested wood or bark, leaving a bonding surface comprising a remaining portion of fungus infested wood on a profiled board, wherein the profiled board is treated with a liquid comprising a lumber additive, so that the board absorbs the liquid and the remaining portion of the fungus infested wood on the bonding surface acquires a retained concentration of the lumber additive, to form the treated board; one or more pieces of wood joined to the bonding surface along a longitudinal junction to form the composite wood product, so that the composite wood product has an interior and an exterior, and an interior segment of the longitudinal junction is formed by the remaining portion of the fungus infested wood on the bonding surface located in the interior of the composite wood product; wherein the retained concentration of the lumber additive in the interior segment is at least as high as the concentration of the lumber additive at any point on the exterior of the composite wood product.

72. A preserved elongate composite wood product produced from wood that has been infested with a fungus associated with a bark beetle, the composite wood product comprising:
a profiled board produced from lumber profiled to remove a portion of fungus infested wood or bark, leaving a bonding surface comprising a remaining portion of fungus infested wood on a profiled board, so that one or more pieces of wood are joined to the bonding surface along a longitudinal junction to form the composite wood product, so that the composite wood product has an interior and an exterior, and an interior segment of the longitudinal junction is formed by the remaining portion of the fungus infested wood on the bonding surface located in the interior of the composite wood product, and so that the remaining portion of the fungus infested wood extends from the bonding surface in the interior of the composite wood product to the exterior of the composite wood product, forming a channel of fungus infested wood from the exterior to the interior of the composite wood product; the composite wood product is treated with a liquid comprising a lumber additive, so that the composite wood product absorbs the liquid through the channel of fungus infested wood, to deliver the lumber additive to the remaining portion of the fungus infested wood on the bonding surface, so that the remaining portion of the fungus infested wood on the bonding surface acquires a retained concentration of the lumber additive, to form a preserved elongate composite wood product.

73. The composite wood product of claim 71, wherein the wood is selected from more than one species of wood, whereby the composite wood product comprises a combination of wood species.

74. The composite wood product of claim 73, wherein the wood is selected from among spruce, pine, and fir.

75. The composite wood product of claim 74, wherein said bark beetle is selected from one of the following: MPB, Western Pine Beetle, Douglas Fir Beetle, Spruce Beetle, and Southern Pine Beetle.

76. The composite wood product of claim 74, wherein said fungus is associated with a bark beetle selected from one of the following: MPB, Western Pine Beetle, Douglas Fir Beetle, Spruce Beetle, and Southern Pine Beetle.

77. The composite wood product of claim 76, wherein said fungus is selected from one of the following: Grosmannia clavigera, Ophiostoma montium, Ophiostoma calvigerum, and Leptographium longiclavatum.

78. The composite wood product of claim 77, wherein said lumber additive kills said fungus.

79. The composite wood product of claim 78, wherein said lumber additive is a wood preservative.

80. The composite wood product of claim 78, wherein said lumber additive kills termites.

81. The composite wood product of claim 78, wherein said lumber additive prevents termite infestation in said composite wood product.

82. The composite wood product of claim 71, wherein said longitudinal junction encapsulates a passage.

83. The composite wood product of claim 82, wherein said passage can receive a reinforcement bar.

84. The composite wood product of claim 82, wherein said passage can receive a pipe.

85. The composite wood product of claim 82, wherein said passage can receive a wire.

86. A compound composite wood product comprising multiple laminations of the composite wood product of claim 71.
